(19) United States
(12) Patent Application Publication
(10) Pub. No.: US 2022/0138821 A1
(43) Pub. Date: May 5, 2022

(54) Vehicular Service Request - Data Logging System and Method

(71) Applicant: Alexander Savenok, Grandview, MO (US)

(72) Inventor: Alexander Savenok, Grandview, MO (US)

(21) Appl. No.: 17/515,046

(22) Filed: Oct. 29, 2021

Related U.S. Application Data
(60) Provisional application No. 63/107,288, filed on Oct. 29, 2020.

(51) Int. Cl. G06Q 30/06; G07C 5/00; G07C 5/08

(52) U.S. Cl. CPC G06Q 30/0611; G07C 5/0808; G07C 5/008

(57) ABSTRACT

A vehicular service request, log mapping, and bidding system according to the present invention preferably includes at least three and preferably four critical components, including an Electronic Logging Device or ELD; a Remote Service/ELD Provider Service; a mobile device exemplified by smart phone or tablet computer; and a Log Mapping Service. Log Mapping Services may be optionally provided by the Remote ELD Provider Service. The Electronic Logging Device or ELD, Remote Service/ELD Provider Service, and mobile communications device are preferably in communication with one another via network-based communication channels, while the ELD device 1 and the mobile device are preferably in communication with one another via short range wireless protocol means exemplified by Bluetooth transmission. The system enables a driver/user to communicate service requests to localized service providers who diagnose and bid on services based upon ELD data made known to localized service providers by way of the system.

### PRIOR HISTORY

This application claims the benefit of pending U.S. Provisional Patent Application No. 63/107,288 filed in the United States Patent and Trademark Office (USPTO) on 29 Oct. 2020, the specifications and drawings of which application are hereby incorporated by reference thereto.

### FIELD OF THE INVENTION

The invention generally relates to a system and method for collecting data from a vehicle as part of an Hours of Service or HOS compliance protocol. The invention more particularly relates to a system and method for collecting data from a vehicle via both an electronic logging device and a mobile communications device in close proximity therewith for enabling remote diagnosis and bidding for vehicle repair issues that arise during vehicle operation.

### SUMMARY OF THE INVENTION

The present invention may be said to essentially provide an electronic logging system and method for collecting data from a vehicle-based electronic logging device and mapping the data to a mobile communications device in close proximity with the electronic logging device. The electronic logging system and method according to the present invention may be said to essentially comprise, in combination, an electronic logging device, at least one remote service provider, and at least one mobile communications device. The electronic logging device is outfitted upon a vehicle and configured to collect/record data exemplified by GPS location, engine error logs, and/or a log of vehicle drive time hours. The at least one remote service provider may preferably include at least an ELD service provider or Remote Service/ELD Provider service. The at least one service provider may also preferably provide Log Mapping Services. The essential function of the ELD service provider is to compile/aggregate data collected from the ELD or electronic logging device. The ELD service provider may also provide log mapping services or these services may be provided by a separate service provider.

The at least one remote service provider is preferably in communication with the electronic logging device for aggregating data therefrom. The at least one mobile communications device is preferably outfitted with a non-transitory, computer-implementable mobile software application. The non-transitory, computer-implementable mobile software application is configured for enabling the at least one mobile communications device to communicate with the at least one remote service provider for collecting and correlating data from both the electronic logging device and the at least one mobile communications device in a manner that allows the user to more easily arrange for repair services as required during vehicle operation.

Either the ELD service provider or a separate log mapping services provider preferably provides ELD-mapping services. The ELD-mapping services or processes provided by either the ELD service provider or the separate log mapping service provide may preferably utilize a best fit GPS mapping process with GPS data retrieved from the electronic logging device and the non-transitory, computer-implementable mobile software application. The ELD-mapping services or processes may alternatively utilize unique identifier-mapping whereby a unique identifier is retrieved from the electronic logging device via a wireless communication protocol provided by the non-transitory, computer-implementable mobile software application.

The electronic logging device or ELD is preferably in communication with the at least one remote service provider by way of a network-based communication channel and the at least one mobile communications device is in communication with the at least one remote service provider by way of a short-range wireless communication protocol. The electronic logging system according to the present invention contemplates the inclusion of a vehicle repair bidding system.

The vehicle repair bidding system extends the electronic logging system by way of or through the non-transitory, computer-implementable software application outfitted upon both the user's mobile device and a mechanic-side software application whereby a user may submit a vehicle repair request based on aggregated ELD data, user-provided imagery, video data, or audio data. The vehicle repair bidding system may be made more fully robust when used in combination with a remote vehicle diagnostic system.

The remote diagnostic system extends the electronic logging system through the non-transitory, computer-implementable software application whereby access is granted to electronic log data as mapped to a responding application for enabling diagnostics to be performed on the electronic log data. The user or vehicle driver is enabled to communicate with the diagnostic system via optional video, audio or text-based communication channels simultaneously when (temporary) access is granted to the electronic log data.

An alternative system according to the present invention provides a vehicular service request system. The vehicular service request system is operable to place localized vehicle service providers in communication with vehicle service requesters requiring vehicular service. The vehicular service request system preferably comprises at least one service provider client device; a remote service provider; and at least one service requester client device. Each service provider client device is preferably outfitted with a non-transitory, computer implementable software application for governing functionality of the system at the service provider side.

The remote service provider is outfitted with a server-side version of the a non-transitory, computer implementable software application for maintaining a service provider database and allowing registration of service provider client devices via the non-transitory, computer implementable software application. The remote service provider provides a unique user identification and logs geographic location associated with the service provider client device during a service provider registration.

The service requester client device is also outfitted with the non-transitory, computer implementable software application for enabling a vehicle service requester to initiate a vehicle service request. The system records the vehicle service request, preferably by way of a voicemail or telephone message recording, and associates the vehicle service request with a requester geographic location based on geographic location coordinates.

The remote service provider is configured to then search the service provider database for local service providers (i.e. those service providers within a predetermined radius of the service requester's geographic location as based on geographic coordinates), and sends the vehicle service request to those local service providers. The local service providers are thereby enabled to provide competitive cost estimates for the vehicle service request and the service requester is similarly enabled to accept an offer from a select local service provider by way of the non-transitory, computer implementable software application.

The vehicular service request system may further provide certain means for providing an Estimated Time of Arrival or ETA by select service providers based on reported geographic locations of the select service providers and the service requester. The remote service provider is further able to receive and correlate electronic log data as provided by an electronic logging device as outfitted upon a service request vehicle in close proximity to the service requester client device. The electronic log data may enable the local service providers to provide more comprehensive competitive cost estimates for the vehicle service request by providing the service providers with additional information taken directly from the Electronic Logging Device or ELD.

In this last regard, it will also be recalled the service requester is further enabled to provide a Vehicle Identification Number (VIN) identifier during the vehicle service request, which VIN identifier enables the local service provider(s) to provide more comprehensive competitive cost estimates for the vehicle service request. The non-transitory, computer implementable software application may be further preferably configured to provide status updates to a selected service provider (i.e. a local service provider whose bid or cost estimate and/or ETA has/have been accepted by the servicer requester) and/or the service requester on the status of the vehicle service request. This information may include financial transaction status in connection with the service request and the payment(s) therefor.

### BRIEF DESCRIPTION OF THE DRAWINGS

Other features and objectives of the invention will become more evident from a consideration of the following brief descriptions of patent drawings.

FIG. 1 is a flowchart diagram showing inter-communication pathways between four systemic components, including an electronic logging device, a mobile communications device, a first remote services provider and a second remote services provider.

FIG. 2 is a flowchart diagram showing an overview of the electronic logging device log mapping process according to the present invention.

FIG. 3 is a flowchart diagram showing an overview of a vehicle repair bidding process according to the present invention.

FIG. 4 is a flowchart diagram showing an overview of a remote vehicle diagnostic process according to the present invention.

FIG. 5 is a flowchart diagram showing an overview of an alternative repair service request system according to the present invention whereby a service provider registers with a backend system.

FIG. 6 is a flowchart diagram showing an overview of the alternative repair service request system according to the present invention whereby a service requester requests service via the system.

FIG. 7 is a flowchart diagram showing an overview of a variant of the alternative repair service request system according to the present invention whereby a fleet administrator is able to request repair services for fleet members.

### DETAILED DESCRIPTION OF THE PREFERRED EMBODIMENTS

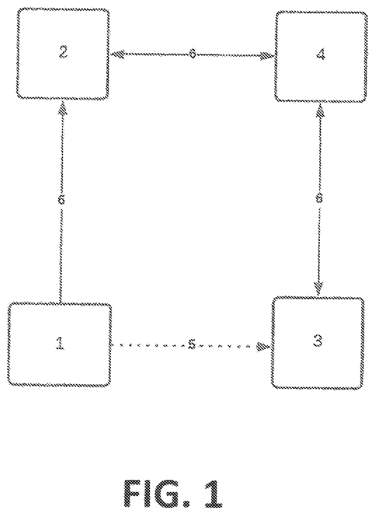

Referencing FIG. 1, the reader will consider the Electronic Logging Device (ELD) Log Mapping and Bidding System according to the present invention preferably comprises four (4) critical components, including an Electronic Logging Device or ELD as at 1; a Remote Service/ELD Provider Service as at 2; a mobile device exemplified by smart phone or tablet computer as at 3; and a Log Mapping Service as at 4. The Electronic Logging Device or ELD 1, Remote Service/ELD Provider Service 2, and mobile device 3 are preferably in communication with one another via network-based communication channels as at 6, while the ELD device 1 and the mobile device are preferably in communication with one another via short range wireless protocol means exemplified by Bluetooth transmission as at 5.

The first component is the Electronic Logging Device or ELD device as referenced at 1. Put simply, an ELI) is an electronic solution that enables professional truck drivers and commercial motor carriers to easily track Hours of Service (HOS) for HOS compliance. All Commercial Driver's License or CDL drivers required to keep a Record of Duty Status (RODS) must use an ELD to document their compliance with HOS rules. Such an ELD device is typically installed in commercial freight vehicles to record GPS location, engine error logs, and log hours.

The ELD device 1 according to the present invention may be a state-of-the-art ELD device 1 and is connected to the engine of a commercial motor vehicle (CMV) and automatically records driving time and thereby ensures integrity of the driver's record of duty status (RODS) and compliance with hours-of-service (HOS) rules. ELD's use a variety of technologies, such as Global Positioning System (GPS), wireless and satellite communications and cloud-based data storage services to track HOS compliance. They have also become integral to overall fleet management, providing motor carriers with a vast amount of data useful for coaching drivers as well as tax and fuel management.

The second component of the present invention is an ELD service provider or Remote Service/ELD Provider service as referenced at 2. ELD service providers primarily function to aggregate data from ELD devices, and report the aggregated data to regulatory agencies on behalf of freight companies. An ELD data provider is a 3rd party service provider that allows some form of 3rd party API access to their end user ELD data. A third component of the system would be a Log Mapping Service Provider as at 4. Log mapping service providers 4 are dedicated to providing log mapping services and bidding services to mobile client devices as at 3. The fourth component of the system is such a mobile device as at 3. A driver may use the mobile device 3 to interact with the Log Mapping Service Provider 4.

It is also possible that the system be devised in such a way that the Log Mapping Service Provider and the Remote Service/ELD Service Provider are unified in a single system, providing ELD reporting and aggregation along with log-to-mobile device mapping, and a bidding system. All communication between components of the FIG. 1 system linked by reference number 6 are preferably in communication with one another over a network-based communication channel here defined as a digital communication channel established over the internet protocol exemplified by IPV4, IPV6 or any future successor to either of these protocols. Communication or data transfer at 5 is preferably established over short-range wireless communication protocols exemplified by Bluetooth, RFID, Wi-Fi or similar short-range wireless communication protocols.

### System Processes

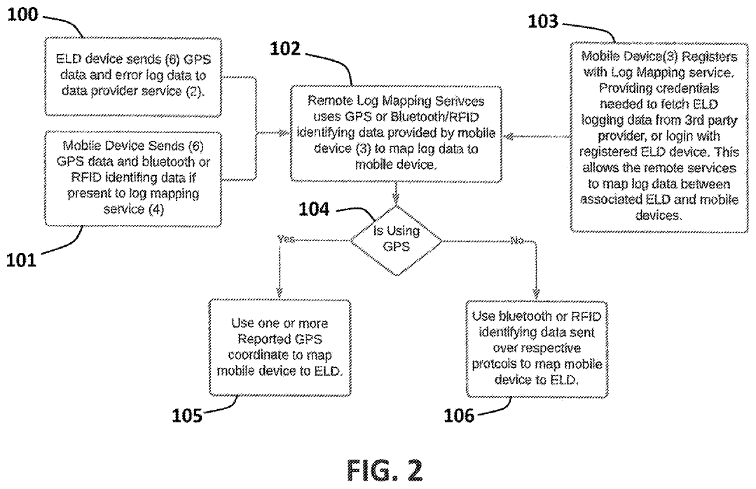

Referencing FIG. 2, the reader will there consider a flowchart depicting electronic logging device log mapping processing according to the present invention. The purpose of the log mapping system generally depicted in FIG. 2 is to map mobile devices 3 to Electronic Logging Devices or ELD devices 1. This is a critical component of the bidding process as the bidding process requires an accurate mapping of ELD data to mobile devices 3, allowing a user to quickly send out ELD data via the network 6. The system makes it simple and easy for a driver to send out repair requests with ELD logs attached, providing a receiving mechanic critical engine log data.

The mapping process begins with 2 data sources, the first of which is the ELD device 1 that reports GPS data, along with engine log and other critical data to the ELD service provider as a t 2. This process is depicted and referenced at box 100. The second data source is the mobile device 3 which also sends GPS data to the Log Mapping Service Provider 4 as depicted and referenced at box 101. The Log Mapping Service Provider or Service 4 then uses the GPS data from both the ELD 1 and the mobile device 3 to map the mobile device 3 to the ELD device 1 as depicted and referenced at box 102. The reader will note this mapping is constrained by device registration, meaning that the mapping only occurs against ELD devices 1 that have been registered under the same account or company as the mobile device 3 as depicted and referenced at box 103.

If the system is able to utilize GPS (as referenced at query 104), the mapping system may preferably use standard coordinate comparison formulae (e.g. Vincenty's formulae). The system first performs a search finding the closest ELD device 1 to the mobile device 3. Ater doing bad data checks (e.g. verifying that the mobile device 3 is within a threshold distance from the ELD device 1), the mapping service checks to see if it has more than one ELD-to-mobile device mapping that passes the bad data check. If so, it compares previous GPS coordinates, until a best fit is found. This process is generally depicted at box 105.

As an alternative to the GPS mapping system, the mobile device 3 may retrieve unique identifying data from the ELD device 1 via a Bluetooth, RFID, or similar signal as depicted at box 106. In this case, mapping is a simple query or request to either the ELD data store, or the ELD data service provider 2. An ELD data store is an internal implementation of all ELD storage requirements in compliance with federal and state regulations, which provides the same level of data as a 3rd party ELD Data provider. The datastore utilizes a database along with remote services to provide the same level of service. Once a mobile device 3 is mapped to log data, the system includes the log data in a repair request. The logging process may be an demand process (mapping occurs once a request for log data is sent from a mobile device 3), or a continuous process.

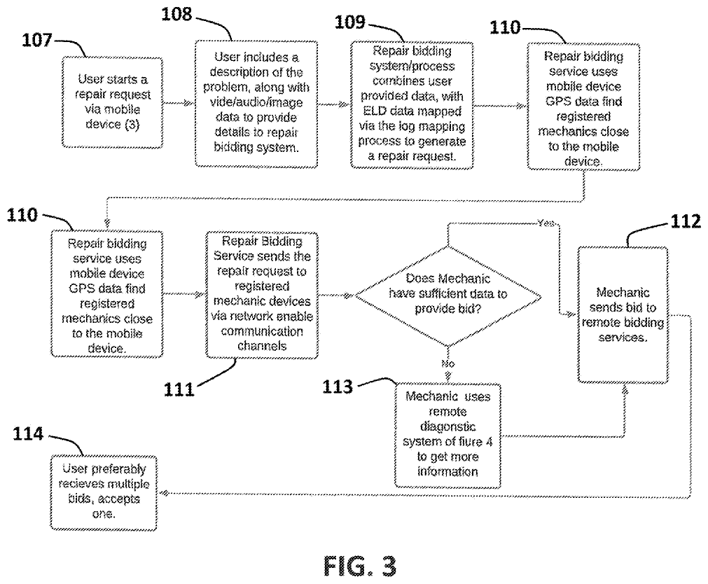

Referencing FIG. 3, the reader will there consider a bidding system and process according to the present invention. The bidding process allows a user utilizing a mobile device 3 and driving a vehicle with an ELD device 1 to generate an electronic repair request as at box 107 via a mobile application made operable via the mobile communication device 3 over a network infrastructure, which includes vital engine log data from the ELD provider or datastore 2. The user would be able to include critical contextual data like video, audio and image files along with a description, that would be combined with the log data to form a repair request as depicted at box 108. In other words, the repair bidding process begins with a user on a mobile device 3 using a mobile application to start a repair request as at 107. Using the application user interface, the user may add multiple images, videos or audio files to a request as at 108.

The application then sends off the request to the Log Mapping Service Provider 4. The repair request may include mobile device GPS data, or the Log Mapping Service Provider may have this historical data continuously sent by the application and stored for log mapping purposes. The bidding process (running within the Log Mapping Service Provider 4) starts the mapping process as described in point 1 above, mapping the requesting mobile device 3 to log data. If mapping is run continuously then the bidding process queries a cache or index with device-to-ELD mappings (e.g. ELD device VIN-to-user UUID mapping, which can bring any number of unique identifiers). Once logs are mapped, a reference thereto or the logs themselves are attached to the repair request as summarized in box 109.

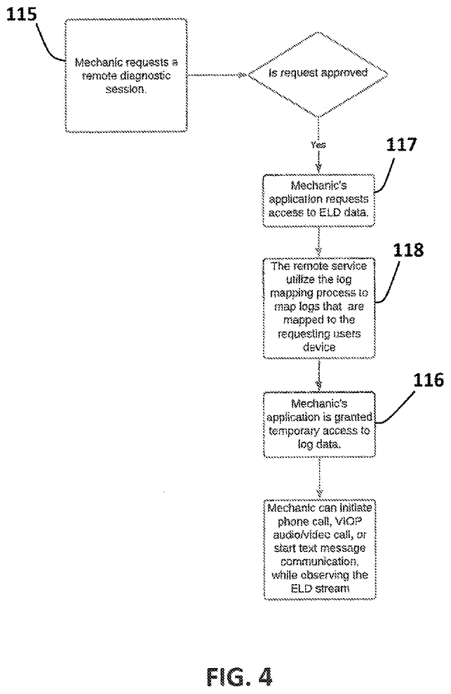

The remote service then locates local mechanics (mechanics are located using user device coordinates from both mechanics utilizing a mobile application and the requesting user's mobile device 3, or mechanic address and requesting user's device 3 coordinates) as at box 110. After locating local mechanics, a request is sent out over an established network base communication channel (exemplified by push notification, socket, HTTP polling, etc. . . . ) as at box 111. Local mechanics may then review the logs and repair details. If sufficient data is present to make a reasonable offer, mechanics may make an offer or put forth a bid as at box 112. If additional data is required the mechanic may request a phone call, send a text message, or establish a real time video call to request additional information. It is also possible that the mechanic could request temporary access to live ELD data, during a call to get data from the engine as a truck driver operates the truck or fulfills diagnostic requests from the mechanic as generally depicted in FIG. 4 and as depicted in box 113.

Referencing FIG. 4, the reader will there consider an exemplary remote diagnostic system or process according to the present invention. The mechanic may send out a request for remote data access authorization as at box 115. The authorization request is sent over a network communication channel established either through the remote services, or via network intermediaries to the requesting user's mobile device 3. If the request is approved, the mechanic's mobile application requests access to ELD data as at box 117. If the request flows through the Log Mapping Service Provider 4, the remote services of the Log Mapping Service Provider 4 notifies the mobile application on the mobile device 3. The mobile application notifies the user of the request using the graphic user interface. If the requests flows through intermediaries to the mobile application, the application likewise notifies the user of the request using the graphic user interface.

If the user approves the services, temporary access may be granted at the application interface of the mechanic as at box 116. The authorization grant may be in the form of a JWT token with a 30-minute expiration, or a grant of temporary access to the mechanics user session with the remote services. The truck driver/requesting user is then given the option of approving temporary access to ELD data. If the truck driver/user approves the request the mechanic application is authorized to request the log data from the remote services 4. The remote services 4 provide access to the log data mapped to the truck driver's mobile device/application 3 as at box 118. Once sufficient data has been collected the mechanic sends off a bid as at box 112. Preferably the requesting user/truck driver receives multiple bids. The user then uses the mobile application user interface to accept the bid as at box 114.

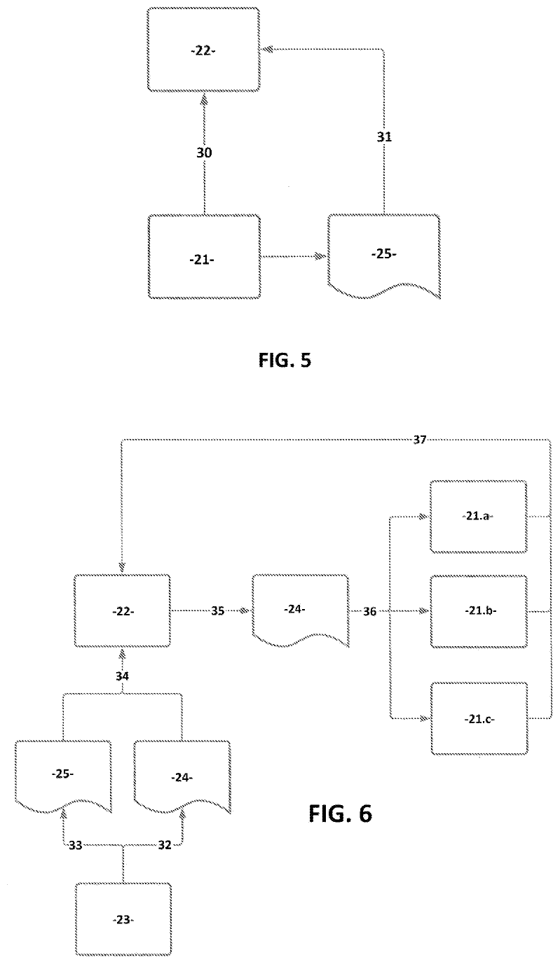

Referencing FIG. 5, the reader will there consider a first alternative embodiment according to the present invention. FIG. 5 essentially illustrates the first stage of the first alternative system, in which service providers via their smartphones, or similar other mobile communications devices, and as outfitted with a non-transitory, computer-implementable software application as at 21, register as at 30 with the backend system 22 through implementation of the software application. The registration process provides a unique user identification associated with the phone number of the smartphone 21 on the remote backend system or services 22.

After registering, the service provider user's mobile device updates as at 31 the remote or backend services 22 with the service provider's location by the service provider's geographic coordinates 25. The service provider thus registers with the remote backend system after which registration process, the system updates with information regarding the service provider's location as compiled via the geographic coordinates of the mobile communications device outfitted with the software application.

FIG. 6 illustrates certain aspects of the next stage of the first alternative system according to the present invention. Referencing FIG. 6, the reader will there consider the service requesting user, using a mobile device as at 23, outfitted with the non-transitory, computer-implementable software application initiates a request for a service. The first step in the service request process is the creation 32 of an audio recording 24 by the service request user through the software application implemented by the mobile device 23. The software application implemented by the service requester mobile device 23 also provides as at 33 the geographic coordinates 25 of the mobile device 23 as a part of the service request.

The audio recording 24 and coordinates 25 are sent as at 34 to the remote or backend system or service 22 which remote or backend system or service 22 maintains a register of service providers and their respective geographic locations. The remote or backend system or service 22 receives the service requesting user's geographic coordinates 25, and implements a database look up to locate nearby registered service providers, and retrieves phone numbers associated with registered service providers as provided during the during the registration process 30.

Using the phone number of a local service provider, the remote or backend system or service 22 sends out as at 35 a phone call through a programmatically enabled phone system or API as exemplified by service offerings of Twilio Inc., with corporate headquarters at 375 Beale Street, Suite 300, San Francisco, Calif., 94105. The phone call sent (as at 35) carries with it audio recording 24 and is played as at 36 to select service provider(s) as at 21.a, 21.b, and/or 21.c, who may then respond as at 37 to the remote or backend system or service 22 through the phone, SMS, or software application, providing the service-requesting user with an estimated price or bid on the repair work. The remote service 22 or mobile application may further generate an associated Estimated Time of Arrival or ETA using standard navigation SDK's or algorithms that are included as a part of the response. The service request user 23 may then then review all received offers from local service providers and respond via the software application by selecting one of the offers.

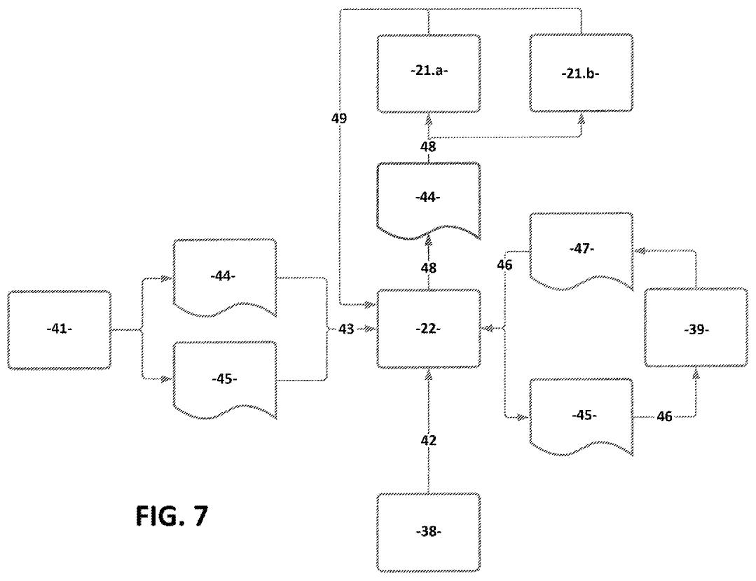

Referencing FIG. 7, the reader will there consider a variant of the first alternative system according to the present invention that combines ELD data, with a fleet administration system, and mobile phones to enable large fleets to quickly locate geographically appropriate service providers. The process begins with an administrative client 38 that registers as at 42 with the remote or backend system or service 22 by providing phone numbers associated with their account and access information for ELD data providers if needed. The ELD data may be sourced from a 3rd party, or from within the system. The system may be implemented by an ELD data provider.

With the associated phone numbers and ELD data, the system is prepared to properly route service requests from account-associated mobile phones as exemplified by mobile device 41. When an account associated mobile phone 41 calls into the system as at 43 via a registered phone number operating through a programmatic phone system or API, the user is preferably prompted to input VIN information. This could be either the full VIN code 45 or enough to uniquely identify the vehicle within the fleet. In this regard, it is contemplated that the last 6 alphanumeric characters of the VIN will usually suffice. The user is also prompted to record an audio message or audio recording 44 describing the type of service required.

The audio recording 44 and Vin data 45 are both delivered as at 43 to the remote or backend system or services 22 via programmatic phone or programmatic phone service provider exemplified by the service offerings of Twilio Inc. The Vin data 45 is then used to look up and return as at 46 vehicle data and geographic coordinates 47 from the ELD data 39. The coordinates 47 are used to locate nearby registered service providers 21 as more fully described in connection with the registration process generally illustrated in FIG. 5.

The remote service then generates as at 48 a programmatic phone call to all nearby registered service providers (as at 21.a and 21.b) playing the recorded audio 44 during the call to every service provider 21 that answers the call. The service provider(s) 21 may then respond as at 49 to the system providing price estimates or bids on the service request(s), and an ETA that can be generated on either service providers device 21 or the remote or backend system or service 22. Using the location 47 of the service requester or user, this location 47 is delivered to the client by certain delivery means if the ETA is generated on the client side (SMS, push, socket etc.). The mobile client would then respond via phone input, SMS, or via the software application. The system may further provide status updates and financial transaction processing to service providers 21 and/or service consumers 23.

While the invention has been illustrated and described in detail in the drawings and foregoing description, the same is to be considered as illustrative and not restrictive in character, it being understood that only preferred embodiments have been shown and/or described and that all changes and modifications that come within the spirit of the invention are desired to be protected. The present invention may be said to essentially provide an electronic logging system for collecting data from a vehicle-based electronic logging device and mapping the data to a mobile communications device in close proximity with the electronic logging device.

The electronic logging system and method according to the present invention may be said to essentially comprise, in combination, an electronic logging device, at least one remote service provider, and at least one mobile communications device. The electronic logging device is outfitted upon a vehicle and configured to collect/record data exemplified by GPS location, engine error logs, and/or a log of vehicle drive time hours. The at least one remote service provider may preferably include at least an ELD service provider or Remote Service/ELD Provider service. The at least one service provider may also preferably provide Log Mapping Services. The essential function of the ELD service provider is to compile/aggregate data collected from the ELD or electronic logging device. The ELD service provider may also provide log mapping services or these services may be provided by a separate service provider.

The at least one remote service provider is preferably in communication with the electronic logging device for aggregating data therefrom. The at least one mobile communications device is preferably outfitted with a non-transitory, computer-implementable mobile software application. The non-transitory, computer-implementable mobile software application is configured for enabling the at least one mobile communications device to communicate with the at least one remote service provider for collecting and correlating data from both the electronic logging device and the at least one mobile communications device in a manner that allows the user to more easily arrange for repair services as required during vehicle operation.

Either the ELD service provider or a separate log mapping services provider preferably provides ELD-mapping services. The ELD-mapping services or processes provided by either the ELD service provider or the separate log mapping service provide may preferably utilize a best fit GPS mapping process with GPS data retrieved from the electronic logging device and the non-transitory, computer-implementable mobile software application. The ELD-mapping services or processes may alternatively utilize unique identifier-mapping whereby a unique identifier is retrieved from the electronic logging device via a wireless communication protocol provided by the non-transitory, computer-implementable mobile software application.

The electronic logging device or ELD is preferably in communication with the at least one remote service provider by way of a network-based communication channel and the at least one mobile communications device is in communication with the at least one remote service provider by way of a short-range wireless communication protocol. Referencing FIG. 1, it will be there be seen that the mobile communications device 3 may preferably communicate with the Log Mapping Service Provider 4 via a network-based communication channel 6 while simultaneously communicating with the ELD 1 via a short-range wireless communication protocol as at 5.

The electronic logging system according to the present invention contemplates the inclusion of a vehicle repair bidding system. The vehicle repair bidding system extends the electronic logging system by way of or through the non-transitory, computer-implementable software application outfitted upon both the user's mobile device and a mechanic-side software application whereby a user may submit a vehicle repair request based on aggregated ELD data, user-provided imagery, video data, or audio data. The vehicle repair bidding system may be made more fully robust when used in combination with a remote vehicle diagnostic system.

The remote diagnostic system extends the electronic logging system through the non-transitory, computer-implementable software application whereby access is granted to electronic log data as mapped to a responding application for enabling diagnostics to be performed on the electronic log data. The user or vehicle driver is enabled to communicate with the diagnostic system via optional video, audio or text-based communication channels simultaneously when (temporary) access is granted to the electronic log data.

An alternative system according to the present invention provides a vehicular service request system. The vehicular service request system is operable to place localized vehicle service providers in communication with vehicle service requesters requiring vehicular service. The vehicular service request system preferably comprises at least one service provider client device as at 21, a remote service provider as at remote services 22, and at least one service requester client device as at 23. Each service provider client device 21 is preferably outfitted with a non-transitory, computer implementable software application for governing functionality of the system at the service provider side.

The remote service provider 22 is outfitted with a server-side version of the a non-transitory, computer implementable software application for maintaining a service provider database and allowing registration of service provider client devices via the non-transitory, computer implementable software application. The remote service provider provides a unique user identification and logs geographic location associated with the service provider client device during a service provider registration.

The service requester client device 23 is also outfitted with the non-transitory, computer implementable software application for enabling a vehicle service requester to initiate a vehicle service request. The system records the vehicle service request, preferably by way of a voicemail or telephone message recording, and associates the vehicle service request with a requester geographic location based on geographic location coordinates as at 25.

The remote service provider 22 is configured to then search the service provider database for local service providers (i.e. those service providers within a predetermined radius of the service requester's geographic location as based on geographic coordinates 25), and sends the vehicle service request to those local service providers. The local service providers are thereby enabled to provide competitive cost estimates for the vehicle service request and the service requester is similarly enabled to accept an offer from a select local service provider by way of the non-transitory, computer implementable software application.

The vehicular service request system may further provide certain means for providing an Estimated Time of Arrival or ETA by select service providers based on reported geographic locations of the select service providers and the service requester. The remote service provider 22 is further able to receive and correlate electronic log data as provided by an electronic logging device as outfitted upon a service request vehicle in close proximity to the service requester client device. The electronic log data may enable the local service providers to provide more comprehensive competitive cost estimates for the vehicle service request by providing the service providers with additional information taken directly from the Electronic Logging Device or ELD.

In this last regard, it will also be recalled the service requester is further enabled to provide a Vehicle Identification Number (VIN) identifier during the vehicle service request, which VIN identifier enables the local service provider(s) to provide more comprehensive competitive cost estimates for the vehicle service request. The non-transitory, computer implementable software application may be further preferably configured to provide status updates to a selected service provider (i.e. a local service provider whose bid or cost estimate and/or ETA has/have been accepted by the servicer requester) and/or the service requester on the status of the vehicle service request. This information may include financial transaction status in connection with the service request and the payment(s) therefor.

Accordingly, although the invention has been described by reference to certain preferred embodiments, and certain associated methodologies, it is not intended that the novel arrangement and methods be limited thereby, but that modifications thereof are intended to be included as falling within the broad scope and spirit of the foregoing disclosures and the appended drawings. Insofar as the description above and the accompanying drawings disclose any additional subject matter that is not within the scope of the claims below, the embodiments are not dedicated to the public and the right to file one or more applications to claim such additional embodiments is reserved.

What is claimed is:

1. A vehicular data logging system, the vehicular data logging system for collecting data from a vehicle, the electronic logging system comprising:
an electronic logging device, the electronic logging device being outfitted upon the vehicle and configured to record vehicle location, record vehicle error logs, and/or log vehicle drive time;
at least one remote service provider, the at least one remote service provider being in communication with the electronic logging device for aggregating data therefrom; and
at least one mobile communications device, the at least one mobile communications device being outfitted with a non-transitory, computer-implementable software application, the non-transitory, computer-implementable software application being configured for enabling the at least one mobile communications device to communicate with the at least one remote service provider for collecting and correlating data from both the electronic logging device and the at least one mobile communications device.

2. The vehicular data logging system of claim 1 comprising an ELD-mapping service provider.

3. The vehicular data logging system of claim 2 wherein ELD-mapping services utilize a best fit GPS mapping process with GPS data retrieved from the electronic logging device and the non-transitory, computer-implementable software application.

4. The vehicular data logging system of claim 2 wherein ELD-mapping services utilize unique identifier-mapping, a unique identifier being retrieved from the electronic logging device via a wireless communication protocol provided by the non-transitory, computer-implementable software application.

5. The vehicular data logging system of claim 1 wherein the electronic logging device is in communication with the at least one remote service provider by way of a network-based communication channel and the at least one mobile communications device is in communication with the electronic logging device by way of a short-range wireless communication protocol.

6. The vehicular data logging system of claim 1 comprising a vehicle service bidding system, the vehicle service bidding system extending the vehicular data logging system through the non-transitory, computer-implementable software application whereby a service requester may submit a service request based on aggregated ELD data, user-provided imagery, video data, or audio data for soliciting a cost estimate from local service providers.

7. The vehicular data logging system of claim 6 comprising a remote diagnostic system, the remote diagnostic system extending the vehicular data logging system through the non-transitory, computer-implementable software application whereby access is granted to the electronic log data for enabling diagnostics to be performed on the electronic log data.

8. A vehicular data logging method for collecting data from a vehicle, the vehicular data logging method comprising the steps of:
outfitting a vehicle with an electronic logging device, the electronic logging device being configured to record vehicle location, record vehicle error logs, and/or log vehicle drive time;
communicating at least one remote service provider with the electronic logging device;
aggregating data by the at least one remote service provider from the electronic logging device;
outfitting at least one mobile communications device with a non-transitory, computer-implementable software application; and
communicating the at least one mobile communications device with the at least one service provider for collecting and correlating data from both the electronic logging device and the at least one mobile communications device via the non-transitory, computer-implementable software application.

9. The electronic logging method of claim 8 wherein ELD-mapping services are provided.

10. The electronic logging method of claim 9 wherein ELD-mapping services utilize a best fit GPS mapping process with GPS data retrieved from the electronic logging device and the non-transitory, computer-implementable software application.

11. The electronic logging method of claim 9 wherein ELD-mapping services utilize unique identifier-mapping, a unique identifier being retrieved from the electronic logging device via a wireless communication protocol provided by the non-transitory, computer-implementable software application.

12. The electronic logging method of claim 8 wherein the electronic logging device is in communication with the at least one remote service provider by way of a network-based communication channel and the at least one mobile communications device is in communication with the electronic logging device by way of a short-range wireless communication protocol.

13. The electronic logging method of claim 8 comprising the steps of:
submitting a vehicle service request by a vehicle service requester via the non-transitory, computer-implementable software application, the service request being based on aggregated ELD data, user-provided imagery, video data, or audio data; and
providing a cost estimate for the service request by at least one vehicle service provider within a predetermined radius of the service requester via the non-transitory, computer-implementable software application.

14. The electronic logging method of claim 13 comprising the step of remotely diagnosing the vehicle based on the vehicle service request, the step of remotely diagnosing the vehicle following a step of granting access to electronic log data as mapped via the non-transitory, computer-implementable software application.

15. A vehicular service request system, the vehicular service request system for placing localized vehicle service providers in communication with vehicle service requesters requiring vehicular service, the vehicular service request system comprising:
a service provider client device, the service provider client device being outfitted with a non-transitory, computer implementable software application;
a remote service provider, the remote service provider maintaining a database and allowing registration of the service provider client device via the non-transitory, computer implementable software application, the remote service provider providing a unique user identification and logging geographic location associated with the service provider client device during a service provider registration; and
a service requester client device, the service requester client device being outfitted with the non-transitory, computer implementable software application, the non-transitory, computer implementable software application enabling a service requester to initiate a vehicle service request, the vehicle service request being recorded and associated with a requester geographic location;
the remote service provider being configured to search the database for local service providers, and sending the vehicle service request to local service providers;
the local service providers thereby being enabled to provide competitive cost estimates for the vehicle service request and the service requester being enabled to accept an offer from a select local service provider by way of the non-transitory, computer implementable software application.

16. The vehicular service request system of claim 15 wherein the vehicle service request is recorded as a phone message recording, the phone message recording being sent to the local service providers.

17. The vehicular service request system of claim 15 wherein an Estimated Time of Arrival or ETA may be provided by select service providers based on reported geographic locations of the select service providers and the service requester.

18. The vehicular service request system of claim 15 wherein the remote service provider is able to receive and correlate electronic log data from the service requester client device in close proximity to an electronic logging device outfitted upon a service request vehicle, the electronic log data for enabling the local service providers to provide more comprehensive competitive cost estimates for the vehicle service request.

19. The vehicular service request system of claim 15 wherein the service requester is enabled to provide a Vehicle Identification Number (VIN) identifier during the vehicle service request, the VIN identifier for enabling the local service providers to provide more comprehensive competitive cost estimates for the vehicle service request.

20. The vehicular service request system of claim 15 wherein the non-transitory, computer implementable software application is configured to provide status updates to a selected service provider and/or the service requester on the status of the vehicle service request.
